(19) United States
(12) Patent Application Publication
(10) Pub. No.: US 2007/0203722 A1
(43) Pub. Date: Aug. 30, 2007

(54) Method for determining a future value of greenhouse gas credits

(76) Inventors: Randall Ray Richards, Chillicothe, IL (US); James Edward Chapman, Washington, IL (US); Noel Joy Rytter, Dunlap, IL (US); Morton Herman Sill JR., Chillicothe, IL (US); Stephen John Pierz, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/363,257

(22) Filed: Feb. 28, 2006

(51) Int. Cl. G06Q 99/00

(52) U.S. Cl. 705/1

(57) ABSTRACT

A method for evaluating a greenhouse gas reduction project is disclosed. The method includes receiving one or more parameters associated with a greenhouse gas reduction project. The method also includes determining an amount of greenhouse gas credits potentially generated during the lifecycle of a greenhouse gas reduction project. The method further includes analyzing historic data associated with a price history of greenhouse gas credits. The method also includes estimating a future value of the greenhouse gas credits based on the analysis trends and inputs. The method further includes predicting a potential revenue generated from a greenhouse gas reduction project based on the future value of the generated greenhouse gas credits.

### TECHNICAL FIELD

This disclosure relates generally to a method for determining a value of greenhouse gas credits and, more particularly, to a method for determining a future value of greenhouse gas credits based on a present emission reduction project.

### BACKGROUND

The emission of greenhouse gas (GHG) into the atmosphere is becoming an issue of international concern particularly since the negotiation of the Kyoto Protocol in late 1997 and, more recently, since Feb. 16, 2005 when the provisions of the Kyoto Protocol came into force. Under the Kyoto Protocol, and similar agreements and legislation, business entities may be responsible for regulating the emission of GHGs such as carbon dioxide (CO₂), nitrous oxide (N₂O), chlorofluorocarbons (CFCs), hyrdrofluorocarbons (HFCs), sulfur hexafluoride (SF₆), and methane (CH₄). To comply with these regulations, some entities may employ GHG-reducing technologies to limit such emissions. Alternatively and/or additionally, entities may purchase GHG credits from other entities that have fully complied with GHG emission regulations and engaged in credit-generating emission-reduction activities, and apply these credits to reduce their own GHG emission levels. As a result, the sale and trade markets for greenhouse gas (GHG) credits is becoming increasingly active.

One technique for generating GHG credits may include, for example, capturing and reducing methane gas emitted from coal seams or decaying matter such as vegetation, animal waste, and landfill materials to reduce its negative effects on the atmosphere. The captured methane gas may, for example, be flared, used as fuel for a power generation plant, or as a generation source for the production of hydrogen fuel. When transformed, methane, which has a global warming potential (GWP) 24 breaks down into carbon dioxide with a GWP of 1. Production of GHG credits is determined by an activity that reduces the amount of carbon dioxide equivalent (CO₂e) gas. Thus, for every metric ton of methane that is transformed to energy and carbon dioxide, approximately 23 GHG credits may be produced corresponding to the net reduction in carbon dioxide equivalent gas emitted into the atmosphere.

These GHG credits, when approved, validated, and certified, may be sold or traded. In some cases, projected revenue earned through the sale of GHG credits generated by a GHG reduction facility, such as a methane combustion power plant, may provide some economic incentive to construct and operate such a facility. Thus, in order to accurately determine the feasibility of constructing and operating a particular GHG reduction facility, an evaluation method that includes accounting for a future value of GHG credits produced in association with the GHG reduction project may be required.

One method for establishing a value of emission reduction benefits based on actual market value is described in U.S. Patent Publication No. 2004/0039684 (“the '684 publication”) to Sandor. The '684 publication describes a system for trading emission reductions via a computer network. The system includes a plurality of workstations coupled to a central server. Each workstation may include a processor operable to execute a program that generates emission reduction benefits, stores the emission reductions benefits in a warehouse, verifies the stored emission reduction benefits, and provides the emission reduction benefits to a buyer at an agreed upon price by a seller, thereby establishing a market value associated with the transaction.

Although the system of the '684 publication may determine a value associated with emission reduction benefits based on present market supply and demand conditions, it may still be inadequate in certain cases. For example, the system of the '684 publication may not be capable of estimating a future value of emission reduction benefits. As a result, entities that rely on estimating future market earnings to evaluate present-day business decisions may become unreliable and/or inefficient. Additionally, the system of the '684 publication cannot estimate a potential amount of GHG credits that may be generated by a facility. Thus, the system of the '684 publication may not adequately support systems that rely on evaluating a project based on predicted GHG reducing activities.

Furthermore, the system of the '684 publication may be costly and unreliable. For example, the system of the '684 publication may only determine emission reduction benefits after a supplier has performed the emission reduction activity. As a result, revenue generated from the sale of emission reduction credits may not cover the costs associated with the emission reduction activities. Thus, the profitability of the supplier may suffer. Additionally, the system of the '684 publication cannot analyze external factors associated with the creation of emission reduction credits, such as external economic impacts and revenue generated from the sale of a product of the emission reduction activity. As a result, entities that rely on complete cost/benefit analysis related to emission reduction activities may become inefficient, as they may not receive all information necessary to make an informed business decision.

The disclosed method for determining a future value of GHG credits is directed towards overcoming one or more of the problems set forth above.

### SUMMARY OF THE INVENTION

In accordance with one aspect, the present disclosure is directed toward a method for evaluating a proposed greenhouse gas reduction project. The method may include receiving one or more parameters associated with the greenhouse gas reduction project. The method may also include estimating an amount of greenhouse gas credits potentially generated during the greenhouse gas reduction project. The method may further include analyzing historic data associated with a price history of greenhouse gas credits. The method may also include estimating a future value of the greenhouse gas credits based on the analysis. The method may further include predicting a potential revenue generated from a greenhouse gas reduction project based on the value of the generated greenhouse gas credits.

According to another aspect, a method for determining a feasibility of a proposed greenhouse gas reduction project is disclosed. The method may include predicting a potential cost associated with operation of the greenhouse gas reduction project. The method may also include estimating a potential revenue generated by the greenhouse gas reduction project, wherein the potential revenue includes one or more of income associated with a future sale of a product of the greenhouse gas reduction project and a future value of greenhouse gas credits generated by the greenhouse gas reduction project. The method may further include assessing the economic feasibility associated with the greenhouse gas reduction project based on the potential cost and revenue associated with the project.

In accordance with another embodiment, a system for evaluating a proposed greenhouse gas reduction project is disclosed. The system may include an interface and a processor coupled to the interface. The processor may be configured to receive, via the interface, one or more parameters associated with the greenhouse gas reduction project. The processor may also be configured to estimate an amount of greenhouse gas credits potentially generated during the greenhouse gas reduction project. The processor may be further configured to analyze historic data associated with a price history of greenhouse gas credits. The processor may also be configured to estimate a future value of the greenhouse gas credits based on the analysis. The processor may be further configured to predict a potential revenue generated from a greenhouse gas reduction project based on the future value of the generated greenhouse gas credits.

### BRIEF DESCRIPTION OF THE DRAWINGS

FIG. 1 illustrates an exemplary system for evaluating a greenhouse gas reduction project consistent with the present disclosure;

FIG. 2 is a flowchart illustration of an exemplary disclosed method performed by the system of FIG. 1; and

FIG. 3 is a flowchart illustration of an exemplary disclosed method for determining an economic feasibility of a GHG reduction project.

### DETAILED DESCRIPTION

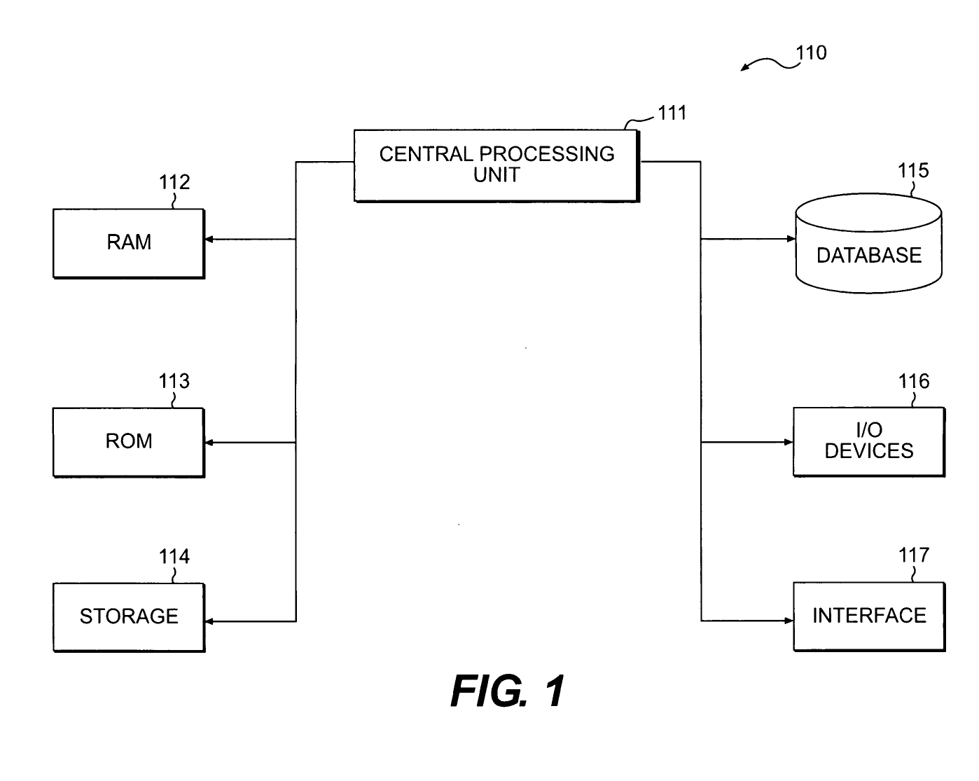

FIG. 1 illustrates an exemplary system 110 in which principles and methods consistent with the disclosed embodiments may be implemented. As shown in FIG. 1, system 110 may include one or more hardware and/or software components configured to collect, monitor, store, analyze, evaluate, distribute, report, process, record, and/or sort information associated with a proposed GHG reduction project. For example, system 110 may include one or more hardware components such as, for example, a central processing unit (CPU) 111, a random access memory (RAM) module 112, a read-only memory (ROM) module 113, a storage 114, a database 115, one or more input/output (I/O) devices 116, and an interface 117. Alternatively and/or additionally, system 110 may include one or more software components such as, for example, a computer-readable medium including computer-executable instructions for performing a method associated with a proposed GHG reduction project. It is contemplated that one or more of the hardware components listed above may be implemented using software. For example, storage 114 may include a software partition associated with one or more other hardware components of system 110. System 110 may include additional, fewer, and/or different components than those listed above. It is understood that the components listed above are exemplary only and not intended to be limiting.

CPU 111 may include one or more processors, each configured to execute instructions and process data to perform one or more functions associated with system 110. For instance, CPU 111 may execute software that enables system 110 to receive one or more parameters associated with a GHG reduction project. CPU 111 may also execute software that estimates an amount of GHG credits that may be generated during the GHG reduction project. CPU 111 may also execute software that analyzes historic data associated with a price of GHG credits. CPU 111 may also execute software that estimates a future value of the GHG credits based on the historical data analysis. CPU 111 may also execute software that determines a potential revenue associated with a GHG reduction project based on the future value of the generated GHG credits.

RAM 112 and ROM 113 may each include one or more devices for storing information associated with an operation of system 110 and/or CPU 111. For example, ROM 113 may include a memory device configured to access and store information associated with system 110, including information for identifying, initializing, and monitoring the operation of one or more components and subsystems of system 110. RAM 112 may include a memory device for storing data associated with one or more operations of CPU 111. For example, ROM 113 may load instructions into RAM 112 for execution by CPU 111.

Storage 114 may include any type of mass storage device configured to store any type of information that CPU 111 may need to perform processes consistent with the disclosed embodiments. For example, storage 114 may include one or more magnetic and/or optical disk devices, such as hard drives CD-ROMs, DVD-ROMs, or any other type of mass media device.

Database 115 may include one or more software and/or hardware components that store, organize, sort, filter, and/or arrange data used by system 110 and/or CPU 111. For example, database 115 may store historical information such as historic price information associated the sale or trade of GHG credits, historic cost information associated with GHG reduction projects, or any other type of historical data. Database 115 may also store project parameters associated with one or more GHG reduction projects such as, for example, design and/or construction plans, requests for quotes (RFQs), project specifications, or any other type of project-related information. It is contemplated that database 115 may store additional and/or different information than that listed above.

I/O devices 116 may include one or more components configured to communicate information with a user associated with system 110. For example, I/O devices may include a console with an integrated keyboard and mouse to allow a user to input parameters associated with system 110. I/O devices 116 may also include a display including a graphical user interface (GUI) for displaying information on a monitor. I/O devices 116 may also include peripheral devices such as, for example, a printer for printing information associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 117 may include one or more components configured to transmit and receive data via any appropriate communication network, such as the Internet, a local area network, a workstation peer-to-peer network, a direct link network, a wireless network, or any other suitable communication platform. For example, interface 117 may include one or more modulators, demodulators, multiplexers, demultiplexers, network communication devices, wireless devices, antennas, modems, and any other type of device configured to enable data communication via any suitable communication network.

System 110 may be configured to collect, analyze, evaluate, and distribute information related to one or more GHG reduction projects. GHG reduction projects may include any activity that reduces and/or limits an amount of GHG emitted into the atmosphere through one or more methods of transformation, combustion, capture, and/or containment. Alternatively and/or additionally, GHG reduction projects may include an activity that converts one type of GHG into another type of GHG (typically one that is deemed to have less net negative environmental effects), through some chemical conversion process. Examples of GHG reduction projects may include methane combustion, methane transformation to an energy storage gas such as hydrogen, methane capture and/or conversion, CO₂ sequestration, CO₂ collection, implementation of and/or investment in renewable energy sources, and manufacture and/or purchase of emission reduction projects. According to one exemplary embodiment, a GHG reduction project may include a methane combustion plant implemented as part of a power generation facility. In another embodiment, a GHG reduction project may include the manufacture and/or sale of GHG emission reducing vehicles and/or machines.

For instance, according to one exemplary embodiment, a GHG reduction project may include development, construction, and operation of a power generation facility. This facility may be adapted to generate power by the combustion of methane gas that may otherwise be emitted into the atmosphere. For example, the facility may be configured to capture methane gas from coal gas, a landfill, a raw sewage plant, bio-mass processor, or other location where decaying matter produces methane gas. The facility may transform the methane gas (which would otherwise be emitted into the environment) into an energy storage media such as hydrogen or fuel an engine or gas turbine to drive a turbine adapted to generated electric power. The transformation of methane produces useful energy plus carbon dioxide, a GHG with 24 times less of the GWP associated with methane, which may result in a net benefit to society and the environment. As a result, for every 1 metric ton of methane that is transformed into carbon dioxide through this process, the equivalent of approximately 23 metric tons of carbon dioxide is prevented from being emitted into the atmosphere, resulting an a net reduction of carbon dioxide equivalent (CO₂e) emissions.

According to another embodiment, a GHG reduction project may include the capture and storage of GHG, thereby preventing its emission into the atmosphere. For example, carbon dioxide may be captured from power generation facilities and injected into subterranean oil fields to aid in the recovery of oil. This injection will not only aid in the recovery of oil and other natural gases, but will reduce the carbon dioxide emitted into the atmosphere.

System 110 may be configured to receive one or more parameters associated with a GHG reduction project. For example, system 110 may receive GHG reduction project parameters input by a user though I/O devices 116. Alternatively and/or additionally, system 110 may receive project parameters via a communication network. For example, system 110 may be configured as a centralized server and may receive the project parameters from one or more users and/or systems via the Internet. For purposes of the present disclosure, project parameters may include any suitable specification and/or characteristic associated with the construction, maintenance, design, and/or operation associated with a GHG reduction project. For example, project parameters for a methane capture power generation facility may include, among other things, land specifications (size requirements, location, etc.); construction specifications and bill of materials; construction, maintenance, and/or operational requirements and costs; power plant specifications (including power generation capacity, fuel (e.g., methane) consumption, etc.); or any other suitable parameter associated with the project.

System 110 may be configured to estimate an amount of GHG credits that could be generated during the GHG reduction project. For example, CPU 111 associated with system 110 may execute software that estimates and/or projects a quantity of GHG credits that may be generated by the project based on a potential reduction of GWP equivalent emissions into the environment. Because different GHG have different effects on the environment, the amount is based not only on the amount of the particular gas emission, but on the type of gas that is emitted. For instance, each GHG has been assigned a global warming potential (GWP) by the Intergovernmental Panel on Climate Change (IPCC), established by the World Meteorological Organization (WMO) and the United Nations Environment Programme (UNEP). The GWP is a measure that is used to determine the ability of each particular GHG to trap heat over time in the atmosphere and is normalized to the GWP of carbon dioxide. For example, carbon dioxide is assigned a GWP of 1. Other GHGs, such as methane, nitrous oxide, sulfur hexaflouride, and various types of CFCs and HFCs are assigned multiples of the GWP of carbon dioxide representing the amount of carbon dioxide emission that is equivalent per unit emission of the respective gas. For instance, methane is assigned a GWP of 24, indicating that 1 unit of methane in the environment is equivalent to 24 units of carbon dioxide. System 110 may estimate an amount of GHG credits that could be generated by a GHG reduction project by estimating the net reduction in GWP of the total emitted GHG. For example, as explained above, because carbon dioxide has a GWP of 24 times less than that of methane, system 110 may predict a net GWP reduction associated with a process that coverts a certain amount of methane to useful energy and carbon dioxide. Accordingly, emission reduction credits may be estimated, based on the predicted GWP equivalent reduction estimated for a proposed GHG reduction project. This estimated reduction is typically reviewed, validated, and approved by a governing body prior to the commencement of the project.

System 110 may be configured to analyze historic data associated with a price history of GHG credits. For example, CPU 111 may execute software that monitors GHG credit price histories from one or more GHG credit trading markets via a communication network. CPU 111 may be configured to store the monitored price histories in storage 114 and/or database 115. CPU 111 may execute software that analyzes historical GHG credit prices to estimate, speculate, and/or predict market trends associated with the price and/or costs of GHG emission credits.

System 110 may estimate a value of GHG credits generated by the GHG reduction project based on the analysis. For example, system 110 may be configured to estimate a future value associated with an amount of GHG credits generated by a proposed GHG-reduction project based on the historical price information. Alternatively and/or additionally, it is contemplated that the future value may be estimated based on additional criteria such as, for example, a projected supply increase, a projected increase in demand for GHG credits produced from particular sources, a projected tightening of GHG emission laws, or any other criteria. For example, in addition to using historical price information, system 110 may be configured to account for GHG demand increases (which may be caused by legislative actions in one or more countries to curb GHG emissions and/or penalize offenders). Accordingly, system 110 may be configured to estimate a future value (or a plurality of future values) based on any suitable criteria potentially impacting GHG prices in the future. It is also contemplated the CPU 111 may execute software that, for each future value generated, a report may be generated accounting for the assumptions made in the determination of the future value.

System 110 may also be configured to predict revenue generated from a GHG reduction project based on the value of GHG credits that may be potentially generated. This prediction may be based on the future sale of the GHG emission credits. Alternatively and/or additionally, revenue predictions associated with the GHG reduction project may be based on future sales from peripheral activities associated with the reduction project. According to one embodiment, potential revenue generated from a methane capture power generation facility that collects methane gas from a natural source (e.g., waste decay, etc.) may be estimated based on a future sale of GHG credits that could be generated from the methane capture activities and/or the future sale of power that could be generated during a methane combustion process.

According to one embodiment, system 110 may predict one or more potential costs associated with a GHG reduction project. Examples of potential costs may include any cost associated with the project such as, for example, project development costs; purchase or lease of land or other resource used to implement the project; construction costs of a facility to perform the project; purchase of equipment associated with the project; facility maintenance and/or operation costs; repair costs; or any other type of potential cost associated with a GHG reduction project.

System 110 may also be configured to perform a cost/revenue projection associated with the GHG reduction project. For example, CPU 111 may execute software that collects and analyzes one or more potential costs and revenues associated with the GHG reduction project, performs a cost/revenue projection, and generates a report indicative of the projection. According to one exemplary embodiment, system 110 may be configured to determine whether to recommend performance of the GHG reduction project based on the cost/revenue projection. It is also contemplated that the determination may be based on one or more additional criteria supplied by a user of system 110, such as profit expectations, levels of risk, and/or other criteria supplied by a user.

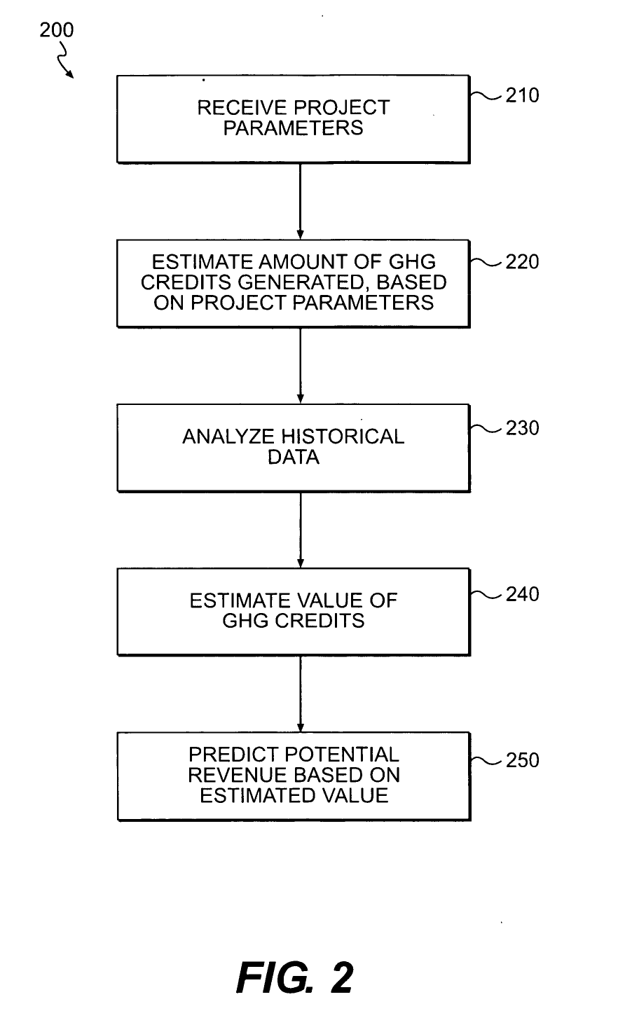

Methods and systems consistent with the disclosed embodiments may provide a system for estimating a future value of a GHG emission credits and provide a feasibility analysis associated with the performance of a GHG reduction project. FIG. 2 provides a flowchart 200 illustrating an exemplary method for evaluating a GHG reduction project consistent with the disclosed embodiments. As illustrated in FIG. 2, the method may include receiving one or more parameters associated with a GHG reduction project (Step 210). These parameters may be input into CPU 111 via I/O devices or communicated to CPU 111 via a communication network. It is contemplated that CPU 111 may determine certain parameters as a function of one or more different project parameters.

Upon receiving project parameters, an amount of GHG credits may be estimated based on one or more received project parameters (Step 220). CPU 111 may predict the number of GHG credits that may be generated by a proposed project, based on an estimated amount of GHG that is captured, reduced, transformed, combusted, converted, limited, and otherwise not permitted to be emitted into the environment by a particular GHG reduction project. This prediction may be based on the received project parameters. For example, according to one embodiment, CPU 111 may predict an amount of GHG credits that may be generated by a methane capture power generation facility based on the amount of methane that may be potentially transformed into energy plus carbon dioxide during the combustion process. According to another embodiment, CPU 111 may predict an amount of GHG credits that may be generated in connection with a manufacturing, production, or application of higher efficiency machines based on the GHG savings that each machine realizes with respect to a baseline of emissions for that machine.

Once an amount of GHG credits associated with a particular project has been predicted, historical information associated with GHG credits may be analyzed (Step 230). Historical information may include, among other things, data associated with a sale price, a demand, a supply, and/or a trade volume associated with the brokering and trading of GHG credits. This information may be collected automatically by CPU 111 via a communication network (e.g., the Internet) or received by a user via I/O devices 116. CPU 111 may execute software that analyzes the historical information to determine one or more market indicators associated with future values of GHG credits. For example, CPU 111 may analyze historical information associated with past sale prices, supply, and demand to project and/or estimate future trends in the GHG credit market.

Upon analyzing historical information, a value associated with the amount of GHG credits that could potentially be generated by the project may be estimated (Step 240). For example, CPU 111 may execute software that estimates a future value of the GHG credits that may be generated by the project based on historical information and/or projected data determined though historical analysis. This estimated value may include a monetary value, a market share based on historical supply and demand, or any other type of commodity value. For instance, CPU 111 may execute software that predicts an annual value of the GHG credits produced during each of the next twenty years of operation of a methane capture facility.

System 110 may estimate a future revenue associated with the estimated value of GHG credits (Step 250). For example, CPU 111 may predict potential revenue generated by a GHG reduction project based on the aggregate estimated value of the GHG credit portfolio over the life of the project. According to one embodiment, this estimated revenue may include a present income based on future sales associated with the GHG credits. Following the example above, CPU 111 may estimate the revenue that may be generated by the future sale of the GHG credits, based on the estimated value of the GHG credits. In one embodiment, the estimated revenue that may be generated from the credits is expressed as an aggregate future sale price for the estimated value of the GHG credits during each of several market driven economic segments for the course of the operation of the GHG reduction project.

In another embodiment, system 110 may also be configured to determine an economic feasibility associated with a GHG reduction project by analyzing potential costs associated with implementing the GHG reduction project and potential revenues derived from, among other things, the future sale of the GHG credits that could be generated as a result of the project. For example, system 110 may include software that, when executed, may receive a plurality of parameters associated with a GHG reduction project, estimate a potential cost associated with the GHG reduction project based on the received parameters, estimate an amount of GHG credits that may be generated by the GHG reduction project, predict the revenue that may be generated by the GHG reduction project based on a future sale of GHG credits, and perform a cost/revenue projection associated with the GHG reduction project. According to one aspect of the disclosed embodiments, system 110 may produce one or more reports summarizing the feasibility of the project, including cost/revenue projection summaries. Alternatively and/or additionally, system 110 may provide alternative cost/revenue scenarios based on various cost and/or revenue assumptions. System 110 may also provide recommendations and/or projections for modifying one or more of the project parameters to illustrate an effect that each parameter has on the cost/revenue projections.

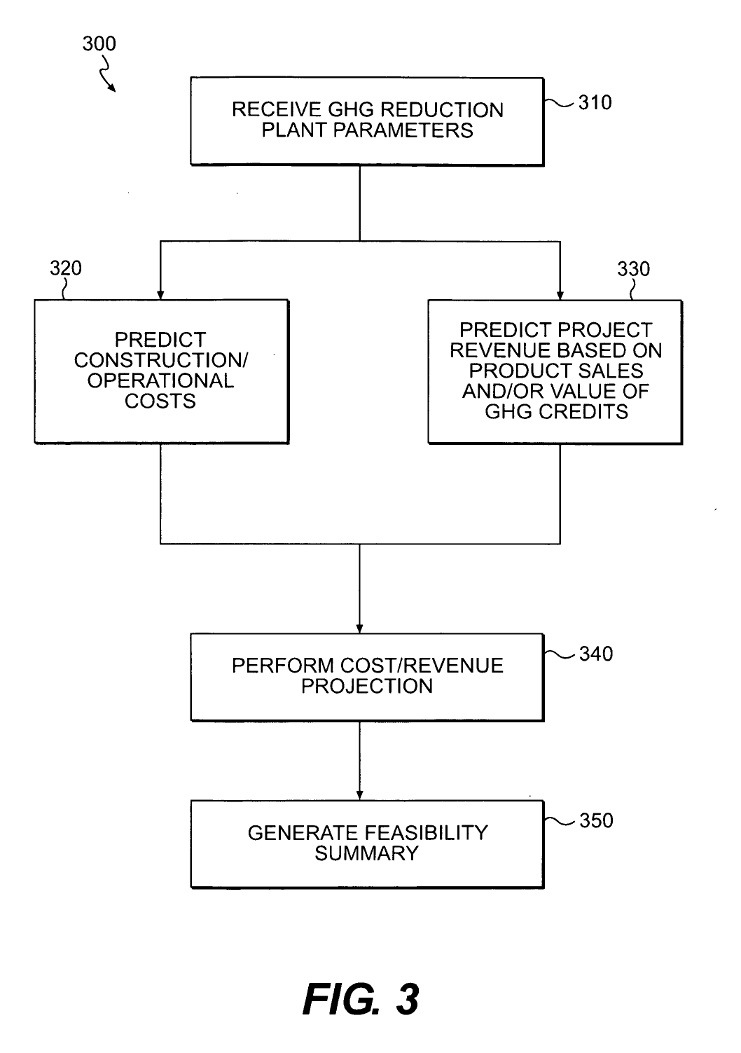

Flowchart 300 of FIG. 3, illustrates an exemplary method for determining the feasibility of a GHG reduction project. The method may include receiving one or more parameters associated with a GHG reduction project (Step 310). For example, CPU 111 may receive project parameters from a user via one or more I/O devices 116. Alternatively and/or additionally, CPU 111 may receive project parameters from one or more other systems via a communication network.

Once project parameters have been received, potential costs associated with the project may be estimated (Step 320). Potential costs may include any future expenditure related to the maintenance, development, construction, manufacturing, repair, and/or operation of the project such as, for example, land purchase or lease, and preparation costs, facility design and/or construction costs, personnel costs, facility maintenance, repair, and operational costs, raw material costs, or any other cost related to the proposed project. For example, CPU 111 may estimate a projected cost associated with the future development, construction, and operation of a GHG reduction project that includes a facility for manufacturing low emission machines. These costs may include one-time costs (such as site planning and development) and/or recurring costs (such as facility maintenance and personnel costs).

Similarly, potential revenue associated with the project may be estimated (Step 330). Estimating the potential revenue may include predicting an amount of GHG credits generated over the duration of the project and estimating the income resulting from the future sale of the credits. Alternatively and/or additionally, in addition to the future sale of GHG credits that may be generated by the project, potential revenue may also include income related to a future sale of energy or a product that may be produced from or by the GHG reduction project. Following the example above, potential revenue may include the future sale of machines produced by the low emission facility along with any GHG credits generated by each machine that is manufactured by the plant. These credits may be packaged with future sales of the vehicle, so that the end-user of the machine may benefit from the GHG credits. Alternatively, the potential GHG credits may be sold and/or traded separate from the sale of the machine. It is contemplated that potential revenue that may be generated from the packaging and sale of GHG credits produced from the sale of low emission machines may be packaged and sold in lots, such that each lot may include GHG credits associated with a plurality of machines. It is also contemplated that CPU 111 may execute software that predicts and/or estimates future GHG credit values based on historical price data.

Once the potential project costs and revenues have been estimated, a cost/revenue projection may be performed to determine the economic feasibility of the project (Step 340). CPU 111 may provide a feasibility report summarizing cost/revenue projection (Step 350). This report may include one or more project recommendations, including potential cost reducing and/or revenue increasing measures. The report may also include any assumptions made in the analysis, such as projected sales estimates, cost structures, land costs, etc. It is contemplated that system 110 may provide a user with options to select certain information, such as future price increases, cost projections, etc., in order to allow a user to customize a set of economic analysis conditions. Following the example above, a user may wish to exclude certain cost analysis for a manufacturing facility associated with the production of low emission machines. Alternatively, a user may wish to provide a more conservative revenue analysis, by adjusting the time-based future prices associated with the GHG credits. According to one embodiment, system 110 may provide a fully interactive interface that allows a user to produce multiple scenarios related to a particular GHG reduction project.

### INDUSTRIAL APPLICABILITY

Although the disclosed system for evaluating a GHG reduction project is described in connection with certain GHG reducing activities, the system may be used in any environment where it may be advantageous to estimate a future value of a commodity sale in order to evaluate a production project. Specifically, systems consistent with the disclosed embodiment may receive one or more project parameters, estimate a future value of GHG credits that may be generated by the project, and evaluate the GHG reduction project based on a future sale of credits that may be generated by the project.

The presently disclosed system for evaluating a GHG reduction project may include several advantages. For example, because system 110 may be configured to estimate an amount of GHG credits produced by a particular project and predict a future value of these credits based on historical market trends, business entities may efficiently determine the economic implications of engaging in certain GHG reducing activities. As a result, system 110 may provide a method for estimating the future revenues associated with the reduction project in order to determine what, if any, reduction activities may be the most profitable and/or socially responsible. Accordingly, by employing processes consistent with system 110, a business entity may estimate that certain GHG reduction activities are more profitable and/or socially responsible than others prior to making substantial financial investment.

Additionally, system 110 may provide processes that allow a business entity to model future costs and revenue structures associated with GHG reduction projects, in order to increase profit. For instance, a business entity employing methods consistent with system 110 may perform several different cost/revenue projections, each with different cost and revenue assumptions. As a result, system 110 may allow a business entity to perform an iterative analysis to predict certain cost and revenue structures, ultimately selecting the one which provides the largest margin of profit and/or improvement in sustainable development.

It will be apparent to those skilled in the art that various modifications and variations can be made to the disclosed system for evaluating a GHG reduction project and associated method without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for evaluating a proposed greenhouse gas reduction project, comprising:
receiving one or more parameters associated with a proposed greenhouse gas reduction project;
estimating an amount of greenhouse gas credits potentially generated during the proposed greenhouse gas reduction project;
analyzing historic data associated with a price history of greenhouse gas credits;
estimating a future value of the greenhouse gas credits based on the analysis; and
predicting a potential revenue generated by the proposed greenhouse gas reduction project based on the future value of the greenhouse gas credits.

2. The method of claim 1, wherein the greenhouse gas reduction project includes development, construction, and operation of a methane combustion plant.

3. The method of claim 1, wherein the price history is determined from one or more previous sales of greenhouse gas credits.

4. The method of claim 1, wherein historic data includes a market trend and the future value is determined by:
estimating a demand based on market indicators associated with the historic data; and
determining a future sale price based on the estimated demand.

5. The method of claim 1, further including:
predicting a potential cost associated with the greenhouse gas reduction project; and
generating a cost/revenue projection based on the predicted cost and revenue associated with the greenhouse gas reduction project.

6. The method of claim 5, wherein the potential cost includes a development and construction cost associated with the greenhouse gas reduction project.

7. The method of claim 5, wherein the potential cost includes an operation cost associated with the greenhouse gas reduction project.

8. The method of claim 5, wherein generating the cost/revenue projection includes determining whether to perform the greenhouse gas reduction project based on the cost/revenue projection.

9. A method for determining a feasibility of a proposed greenhouse gas reduction project, comprising:
predicting a potential cost associated with an operation of the greenhouse gas reduction project;
estimating a potential revenue potentially generated by the greenhouse gas reduction project, wherein the potential revenue includes one or more of income associated with a future sale of a product associated with the greenhouse gas reduction project and a future value of greenhouse gas credits potentially generated by the greenhouse gas reduction project; and
assessing the economic feasibility associated with the greenhouse gas reduction project based on the potential cost and revenue associated with the project.

10. The method of claim 9, wherein the potential cost includes a development and construction cost or an operational cost associated with the greenhouse gas reduction project.

11. The method of claim 9, wherein the future value of the greenhouse gas credits is estimated based on historic data associated with greenhouse gas credits.

12. The method of claim 11, wherein the historic data includes a price history associated with the sale of substantially similar greenhouse gas credits.

13. The method of claim 11, wherein historic data includes a market trend and the future value is determined by:
estimating a future demand based on market indicators associated with the historic data; and
determining a future sale price based on the estimated demand.

14. A system for evaluating a proposed greenhouse gas reduction project, comprising:
an interface;
a processor coupled to the interface and configured to:
receiving one or more parameters associated with a proposed greenhouse gas reduction project;
estimating an amount of greenhouse gas credits potentially generated during the proposed greenhouse gas reduction project;
analyzing historic data associated with a price history of greenhouse gas credits;
estimating a future value of the greenhouse gas credits based on the analysis; and
predicting a potential revenue generated by the proposed greenhouse gas reduction project based on the future value of the greenhouse gas credits.

15. The system of claim 14, wherein the greenhouse gas reduction project includes development, construction and operation of a methane transformation plant.

16. The system of claim 14, wherein potential revenue generated during the greenhouse gas reduction project further includes a potential income associated with a future sale of a product potentially generated by the greenhouse gas reduction project.

17. The system of claim 14, wherein the price history is determined from one or more previous sales of greenhouse gas credits.

18. The system of claim 14, wherein historic data includes a market trend and the future value is determined by:
estimating a demand based on market indicators associated with the historic data; and
determining a future sale price based on the estimated demand.

19. The system of claim 14, further including:
predicting a potential cost associated with the greenhouse gas reduction project; and
generating a cost/revenue projection based on the predicted cost and revenue associated with the greenhouse gas reduction project.

20. The system of claim 19, wherein the potential cost includes a development and construction cost or an operational cost associated with the greenhouse gas reduction project.
